(19) United States
(12) Patent Application Publication
(10) Pub. No.: US 2007/0155275 A1
(43) Pub. Date: Jul. 5, 2007

(54) METHOD OF MANUFACTURING SURFACE LIGHT SOURCE DEVICE AND APPARATUS FOR THE SAME

(75) Inventors: Kyeong Taek Jung, Suwon-si (KR); Dong Woo Kim, Suwon-si (KR); Hyung Bin Youn, Suwon-si (KR)

Correspondence Address: BEYER WEAVER LLP, P.O. BOX 70250, OAKLAND, CA, 94612-0250, US

(73) Assignee: SAMSUNG CORNING CO., LTD., Suwon-si (KR)

(21) Appl. No.: 11/611,673

(22) Filed: Dec. 15, 2006

(30) Foreign Application Priority Data
Dec. 29, 2005 (KR) 10-2005-0134000

(51) Int. Cl. H01J 9/00

(52) U.S. Cl. 445/60

(57) ABSTRACT

There are provided a method of manufacturing a surface light source device, and an apparatus for manufacturing a surface light source device using the method. According to the method, a light source body including a plurality of discharge spaces into which a discharge gas is injected is formed. Impurities being present in the discharge spaces are removed. A mercury gas is diffused into the discharge spaces. Then, the light source body is rapidly cooled from the temperature at which mercury exists in the gaseous state to a room temperature. The time for the mercury gas to be within the range of temperature at which the mercury gas is liquefied is significantly shortened, thereby preventing the liquefied mercury from moving to the region having a low temperature in the discharge spaces.

### BACKGROUND OF THE INVENTION

1. Technical Field

The present invention relates to a method of manufacturing a surface light source device and an apparatus for the same, and more particularly, to a method of manufacturing a surface light source device which emits light in the form of a surface, and an apparatus which is used for performing the same.

2. Discussion of Related Art

In general, liquid crystal (LC) has an electrical characteristics and an optical characteristic. Arrangement of the LC is changed according to the direction of an electric field by the electrical characteristics, and optical transmissivity is changed according to the arrangement by the optical characteristic.

A liquid crystal display (LCD) device displays an image, using the electrical and optical characteristics of the LC. Since the LCD device is very small in size and light in weight, compared to a cathode-ray tube (CRT) device, it is widely used for portable computers, communication products, liquid crystal television (LCTV) receivers and aerospace industry.

To control the LC, the LCD device needs a liquid crystal controlling part for controlling the LC, and a light supplying part for supplying light to the LC.

The liquid crystal controlling part includes a number of pixel electrodes disposed on a first substrate, a single common electrode disposed on a second substrate, and liquid crystal interposed between the pixel electrodes and the common electrode. The number of pixel electrodes correspond to resolution, and the single common electrode is placed in opposite to the pixel electrodes. Each pixel electrode is connected to a thin film transistor (TFT) so that each different pixel voltage is applied to the pixel electrode. An equal level of a reference voltage is applied to the common electrode. The pixel electrodes and the common electrode are composed of a transparent conductive material.

The light supplying part supplies light in the LC of the liquid crystal controlling part. The light passes through the pixel electrodes, the LC and the common electrode sequentially. The display quality of an image passing through the LC significantly depends on brightness of the light supplying part, and uniformity of brightness thereof. Generally, as the brightness and the uniformity of brightness are high, the display quality is improved.

In a conventional LCD device, the light supplying part generally uses a cold cathode fluorescent lamp (CCFL) in a bar-shape or a light emitting diode (LED) in a dot-shape. The CCFL has high brightness and long life of use and generates a small amount of heat, compared to an incandescent lamp. The LED has high brightness. However, in the conventional CCFL or LED, the brightness is not uniform.

Therefore, to increase the uniformity of brightness, the light supplying part using the CCFL or LED as a light source includes optical members, such as a light guide panel (LGP), a diffusion member and a prism sheet. Consequently, the LCD device using the aforementioned CCFL or LED becomes large in size and heavy in weight due to the optical members.

To solve the aforementioned problem, a surface light source in a flat panel shape is suggested. As conventional surface light source devices, there are a surface light source device in which a plurality of discharge spaces are formed by using independent partitions, and a surface light source device in which a plurality of discharge spaces are formed by integrated partitioning parts formed by a corrugated substrate.

The conventional surface light source device using independent partitions includes a first substrate, a second substrate positioned above the first substrate, and a sealing member, positioned between the edges of the first and second substrates, for defining an inner surface. Independent partitions are positioned in the inner space, thereby dividing the inner space into a plurality of discharge spaces into which a discharge gas including a mercury gas is injected. A fluorescent layer is formed on the inner surfaces of the first and second substrates. An electrode for applying a voltage to the discharge gas is formed, along the outer surfaces of both side edges of the first and second substrates.

The conventional surface light source device using a corrugated substrate includes a first substrate and a second substrate positioned on the first substrate. The second substrate is corrugated to form a plurality of integrated partitioning parts. The partitioning parts contact with the first substrate, thereby forming a plurality of discharge spaces into which a discharge gas is injected. The extreme outer partitioning parts are connected to the first substrate by frit for sealing. A fluorescent layer is formed on the inner surfaces of the first and second substrates. An electrode for applying a voltage to the discharge gas encloses the outer edge of the first and second substrate.

The conventional surface light source device using independent partitions is manufactured by the following method: The sealing member is formed on the edge of the first substrate. Partitions are formed on the middle of the first substrate. The second substrate is connected onto the sealing member and the partitions, thereby completing a light source body. The light source body includes an exhaust hole and a mercury injecting hole.

Through the exhaust hole, the inside of the light source body is exhausted, and the light source body is heated to remove impurities being present in the light source body. Through the mercury injecting hole, a mercury getter is injected into the light source body. The mercury getter is activated by heating the light source body at a temperature of 250° C or higher. A mercury gas is generated from the mercury getter being heated, so that the mercury gas is diffused inside the light source body.

Finally, the electrode is formed on the outer surface of both side edges of the first and second substrates. The electrode may be formed by attaching conductive tape or applying conductive paste.

However, in the method of manufacturing the conventional surface light source device, after the mercury gas is diffused inside the light source body, the light source body is annealing-treated to a room temperature. That is, in the method of manufacturing the conventional surface light source device, the light source body is slowly cooled down to a room temperature. Herein, liquefied mercury has the characteristic of being very sensitive to temperature. That is, the liquefied mercury leans to the portion where temperature is relatively low. Considering the mass of mercury required in the surface light source device, the mercury gas inside the discharge spaces starts being liquefied at 150° C. to 250° C.

Accordingly, during the light source body is annealing-treated to a room temperature from a temperature of 250° C., the mercury gas is liquefied within the range of 150° C. to 250° C. As the liquefied mercury is collected in the region having a relatively low temperature inside the light source body, mercury is not uniformly distributed inside the light source body. The region which lacks mercury inside the light source body becomes a dark or pinky region, and consequently the uniformity of brightness of the surface light source device significantly deteriorates.

### SUMMARY OF THE INVENTION

Therefore, the present invention is directed to provide a method of manufacturing a surface light source device which uniformly distributes mercury inside a light source body.

Another object of the present invention is to provide an apparatus for performing the aforementioned method.

In accordance with an aspect of the present invention, the present invention provides a method of manufacturing a surface light source device.

In the method of manufacturing a surface light source device, a light source body including a plurality of discharge spaces into which a discharge gas is injected is formed. Impurities being present in the discharge spaces are removed. A mercury gas is diffused into the discharge spaces. Then, the light source body is rapidly cooled from the temperature at which mercury exists in the gaseous state to a room temperature, to shorten the time for the mercury gas to be within the range of temperature at which the mercury gas is liquefied.

In accordance with an exemplary embodiment, a mercury getter for generating mercury gas may be heated at a temperature of 350° C. or higher, and preferably, 400° C. or higher.

In accordance with another exemplary embodiment, the method for manufacturing a surface light source device may further comprise annealing the light source body to the temperature at which mercury exits in the gaseous state.

In accordance with another exemplary embodiment, the light source body may be rapidly cooled by injecting a cooling gas to the light source body.

In another aspect of the present invention, the present invention provides an apparatus for manufacturing a surface light source device.

The apparatus for manufacturing a surface light source device comprises a forming section, an exhaust section, a diffusion section and a rapid-cooling section. The forming section forms a light source body including a plurality of discharge spaces into which a discharge gas is injected. The exhaust section removes impurities being present in the discharge spaces. The diffusion section diffuses a mercury gas into the discharge spaces by heating a mercury getter. The rapid-cooling section rapidly cools the light source body, from the temperature at which mercury exists in the gaseous state to a room temperature.

In accordance with another exemplary embodiment, the rapid-cooling section may include a nozzle for injecting a cooling gas.

In accordance with the present invention, after the mercury gas is diffused in the light source body, the light source body is forcibly cooled rapidly from the temperature at which mercury exists in the gaseous state in the discharge spaces to a room temperature, thereby significantly shortening the time for the mercury gas to be in the range of the temperature at which the mercury gas is liquefied. Accordingly, the liquefied mercury is prevented from moving to the region having a low temperature in the discharge spaces. Consequently, mercury is uniformly distributed within the discharge spaces, so that a surface light source device has the improved uniformity of brightness.

### BRIEF DESCRIPTION OF THE DRAWINGS

The above and other features and advantages of the present invention will become more apparent to those of ordinary skill in the art by describing in detail preferred embodiments thereof with reference to the attached drawings in which:

FIG. 1 is a block diagram illustrating an apparatus for manufacturing a surface light source device according to an embodiment of the present invention;

FIG. 2 is a perspective view illustrating a light source body including independent partitions of the surface light source device manufactured using the apparatus of FIG. 1;

FIG. 3 is a perspective view illustrating a light source body including integrated partitioning parts of the surface light source device manufactured using the apparatus of FIG. 1;

FIG. 4 is a flow chart sequentially illustrating a method of manufacturing a surface light source device using the apparatus of FIG. 1;

FIG. 5 is a picture illustrating the brightness of a conventional surface light source device;

FIG. 6 is a picture illustrating the brightness of a surface light source device manufactured by the method according to an embodiment of the present invention; and

FIG. 7 is a picture illustrating the distribution of mercury inside the surface light source device of FIG. 6.

### DETAILED DESCRIPTION OF THE INVENTION

The present invention will now be described more fully hereinafter with reference to the accompanying drawings, in which preferred embodiments of Is the invention are shown.

Apparatus for Manufacturing a Surface Light Source Device

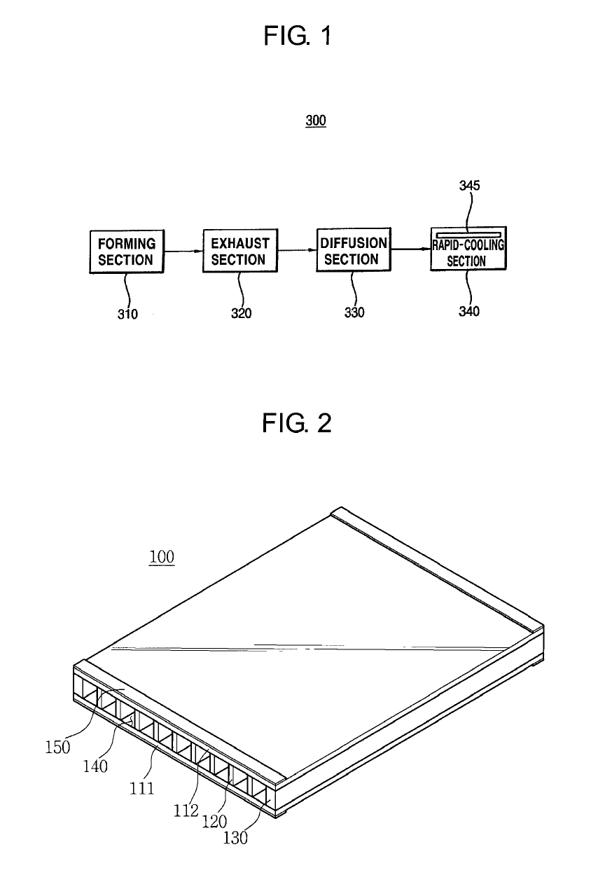

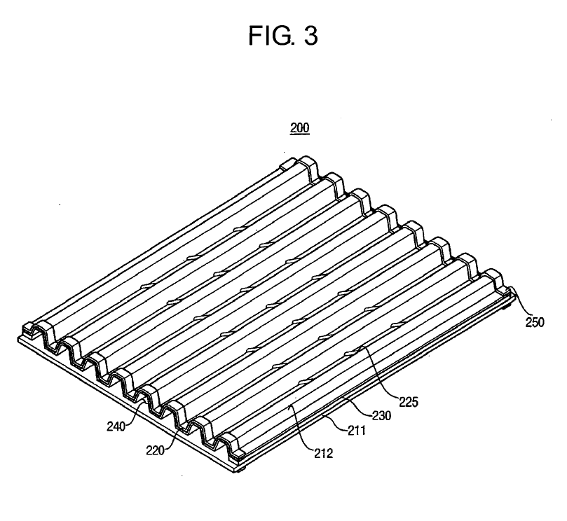

FIG. 1 is a block diagram illustrating an apparatus for manufacturing a surface light source device according to an embodiment of the present invention; FIG. 2 is a perspective view illustrating a light source body including independent partitions of the surface light source device, which is manufactured using the apparatus of FIG. 1; and FIG. 3 is a perspective view illustrating a light source body including integrated partitioning parts of the surface light source device which is manufactured using the apparatus of FIG. 1.

Referring to FIG. 1, the apparatus for manufacturing a surface light source device comprises a forming section 310, an exhaust section 320, a diffusion section 330 and a rapid-cooling section 340.

The forming section 310 forms a light source body including a plurality of discharge spaces into which a discharge gas is injected. For example, the forming section 310 forms a light source body 100 including independent partitions as illustrated in FIG. 2 or a light source body 200 including integrated partitioning parts as illustrate in FIG. 3.

The exhaust section 320 removes impurities being present inside the light source body, by applying vacuum through an exhaust hole formed in the light source body. Accordingly, the exhaust section 320 may include a vacuum pump.

The diffusion section 330 heats a mercury getter injected into the light source body, through a mercury injecting hole formed in the light source body, and the diffusion section 330 sends a mercury gas generated from the mercury getter to the discharge spaces. The diffusion section 330 heats the mercury getter at a temperature of 350° C. or higher, and preferably, at a temperature of 400° C. or higher.

The rapid-cooling section 340 rapidly cools the light source body from the temperature at which the mercury gas inside the discharge spaces exists in a gaseous state to a room temperature. The temperature of liquefying the mercury gas inside the discharge spaces may vary depending on an amount of the mercury gas being injected into the discharge spaces. However, considering the mass of mercury required for a surface light source device, the temperature at which the mercury gas starts being liquefied is about 150° C. to 250° C. Accordingly, the temperature for starting rapid-cooling may be about 150° C. or higher. That is, the rapid-cooling section 340 forcibly cools the light source body as fast as possible, from the temperature at which the mercury gas being present in the discharge spaces exists in the gaseous state to a room temperature, thereby maximally shortening the time for the mercury gas to be in the range of the temperature at which the mercury gas is liquefied. Accordingly, the liquefied mercury is prevented from moving to the region having a low temperature in the discharge spaces. Consequently, mercury is uniformly distributed within the discharge spaces.

The rapid-cooling section 340 with the above-described function may include a nozzle 345 for injecting a cooling gas into the light source body. An example of the cooling gas may be a cooling air. Otherwise, the rapid-cooling section 340 may include a line through which cooling water is circulated, thereby rapid-cooling the light source body using the cooling water.

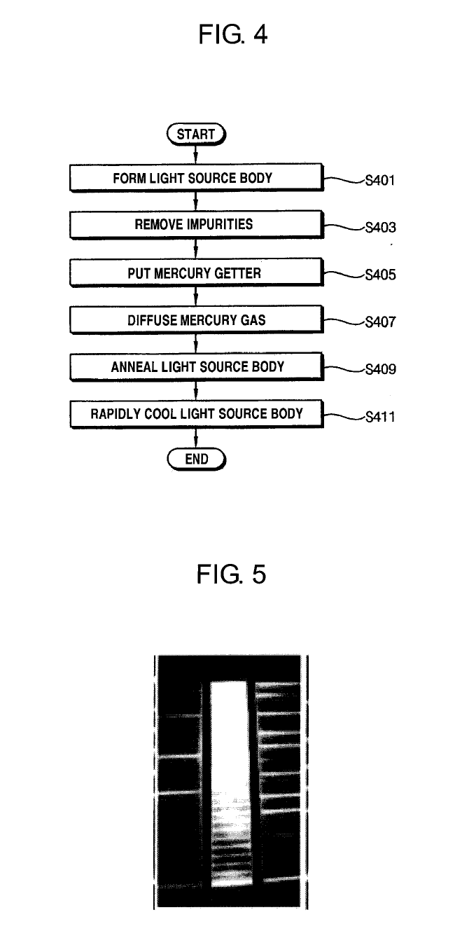

Method of manufacturing surface light source device FIG. 4 is a flow chart sequentially illustrating a method of manufacturing a surface light source device using the apparatus of FIG. 1.

Referring to FIGS. 2 and 4, in step S401, a forming section 310 forms a light source body 100 including independent partitions as illustrated in FIG. 2 or a light source body 200 including integrated partitioning parts as illustrate in FIG. 3.

A method of forming the light source body 100 including independent partitions as illustrated FIG. 2 is as follows. Sealing members 130 are formed on the edges of a first substrate 111. A plurality of partitions 120 are formed on the middle of the first substrate 111, along a first direction. The partitions 120 are positioned in a serpentine structure, to provide a movement passage of a discharge gas. Or, communicating holes may be formed on the partitions 120. The partitions 120 may be formed before the sealing member 130 is formed. A second substrate 112 is connected onto the sealing members and the partitions, thereby forming a plurality of discharge spaces 140. Electrodes 150 are formed on the outer surface at both sides of each of the first and second substrates 111 and 112, thereby completing the light source body 100 including the independent partitions. The electrode 150 may be formed by applying 10 conductive paste or attaching conductive tape.

A method of forming the light source body 200 including integrated partitioning parts as illustrated in FIG. 3 is as follows. Partitioning parts 220, which are formed as a second substrate 212 is corrugated, are connected onto a first substrate 211, thereby forming a plurality of discharge spaces 240 between the first and second substrates 211 and 212. Oblique paths 225 are formed in the second substrate 212. Electrodes 250 are formed on the outer surface at both sides of each of the first and second substrates 211 and 212, thereby completing the light source body 200 including the integrated partitioning parts. The electrode 250 may be formed by applying conductive paste or attaching conductive tape.

In step S403, an exhaust section 320 removes impurities being present in the light source body, by applying vacuum through an exhaust hole of the light source body. The exhaust hole is sealed after the impurities are completely removed.

In step S405, a mercury getter is injected into the light source body through a mercury injecting hole of the light source body.

In step S407, a diffusion section 330 heats the mercury getter at a temperature of 350° C. or higher, and preferably, at 400° C. or higher. Then, a mercury gas generated from the mercury getter is sent into the discharge spaces. The mercury gas being sent is diffused inside the discharge spaces, so as to be uniformly distributed therein.

In step S409, the light source body is annealing-treated from the temperature at which the mercury exists in a gaseous state to the temperature lo before the mercury gas starts being liquefied. That is, the light source body is slowly cooled down to the temperature of 250° C. or 150° C. or higher. As the light source body is annealing-treated to the temperature before the mercury gas is liquefied, the gaseous mercury moves to the region having a low temperature inside the discharge spaces.

In step S411, a rapid-cooling section 340 injects a cooling gas from a nozzle 345 to the light source body, thereby rapidly cooling the light source body from the temperature at which mercury exists in the gaseous state in the discharge spaces to a room temperature. Accordingly, the mercury gas is phase-changed to the liquid state under the liquefaction temperature thereof. If the light source body is slowly cooled down under the liquefaction temperature of mercury, and thus, the liquefied mercury remains for long time under the liquefaction temperature, the liquefied mercury moves to the region having a low temperature in the discharge spaces. However, according to the present invention, when the light source body is rapidly cooled from the temperature above the liquefaction temperature of the mercury gas to a room temperature, there is no sufficient time for the liquefied mercury to move to the region with a low temperature in the discharge spaces. Accordingly, the liquefied mercury is maintained to be uniformly distributed in the discharge spaces.

Consequently, since mercury is uniformly distributed inside the discharge spaces, a dark or pinky region is reduced in the surface light source device. That is, the surface light source device manufactured by the method according to the present invention has the improved uniformity of brightness.

Relation of Amount of Mercury Being Injected to Evaporation Temperature

| Evaporation | Vapor pressure | Number of atoms | | |
|---|---|---|---|---|
| temperature | of mercury P | Inside lamp N | Number of | Mass |
| (° C.) | (Torr) | Nwithin lamp N | moles | (mg) |
| 16 | 0.001 | 1.3 × 10¹⁶ | 2.1 × 10⁻⁸ | 0.0040 |
| 80 | 0.1 | 1.1 × 10¹⁸ | 1.8 × 10⁻⁶ | 0.35 |
| 125 | 1 | 0.94 × 10¹⁹ | 1.5 × 10⁻⁵ | 3.1 |
| 185 | 10 | 0.82 × 10²⁰ | 1.4 × 10⁻⁴ | 26 |
| 250 | 74 | 5.3 × 10²⁰ | 8.8 × 10⁻⁴ | 176 |

When an amount of mercury, which is appropriate for forming a light source device, is 10 mg or more, the temperature at which mercury is liquefied is about 150° C. or less.

Evaluation on Uniformity of Brightness of Surface Light Source Devices

After mercury of 70 mg is diffused at a temperature of 250° C., the light source body is slowly cooled down to a room temperature. Then, the brightness of the light source body is observed, by applying a voltage to the light source body. As illustrated in FIG. 5, the dark region and the pinky region are locally shown in the light source body. This is considered that, as the liquefied mercury slowly moves to the region having a low temperature in the light source body during annealing, mercury is nonuniformly distributed.

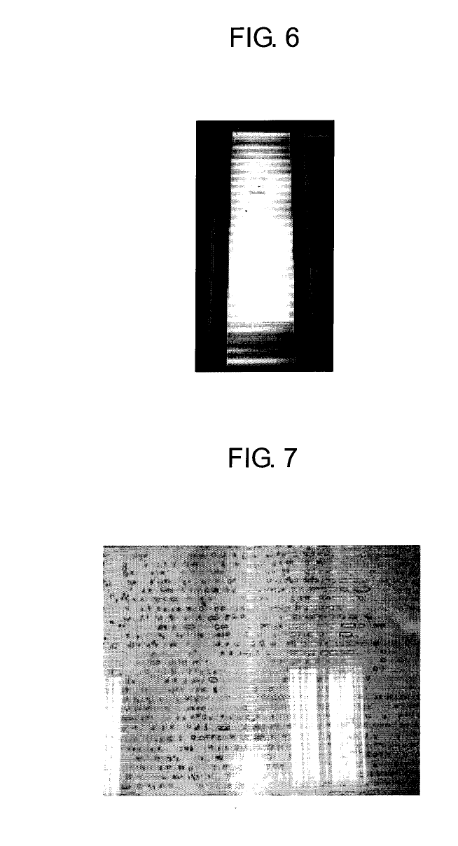

In the other method, after mercury is diffused at a temperature of 400° C., the light source body is rapidly cooled from 200° C. to a room temperature. Then, the brightness of the light source body is observed, by applying a voltage to the light source body. As illustrated in FIG. 6, the dark region and the pinky region are significantly reduced in the light source body, compared to FIG. 5. That is, it is noted that, as illustrated in FIG. 7, the liquefied mercury is uniformly distributed in the light source body. It is understood that, as the light source body is rapidly cooled, no sufficient time is allowed for the mercury gas to stay long within the range of the temperature at which the mercury is liquefied, and no sufficient time is allowed for the liquefied mercury to move to the region having a low temperature in the light source body.

In accordance with the present invention, after the mercury gas is uniformly diffused inside the light source body, the light source body is rapidly cooled to a room temperature, thereby preventing the liquefied mercury from moving to the region having a low temperature. Accordingly, mercury is uniformly distributed in the light source body, so that the surface light source device has the improved uniformity of brightness.

The invention has been described using preferred exemplary embodiments. However, it is to be understood that the scope of the invention is not limited to the disclosed embodiments. On the contrary, the scope of the invention is intended to include various modifications and alternative arrangements within the capabilities of persons skilled in the art using presently known or future technologies and equivalents. The scope of the claims, therefore, should be accorded the broadest interpretation so as to encompass all such modifications and similar arrangements.

What is claimed is:

1. A method of manufacturing a surface light source device, comprising steps of:
forming a light source body including a plurality of discharge spaces into which a discharge gas is injected;
removing impurities being present in the discharge spaces;
diffusing a mercury gas into the discharge spaces; and
rapidly cooling the light source body, from a temperature at which mercury exists in the gaseous state in the discharge spaces to a room temperature.

2. The method of claim 1, wherein the step of diffusing the mercury gas comprises steps of:
putting a mercury getter into the discharge spaces; and
heating the mercury getter at a temperature of 350° C. or higher.

3. The method of claim 2, wherein the mercury getter is heated at a temperature of 400° C. or higher.

4. The method of claim 1, further comprising a step of annealing the light source body to a temperature at which the mercury gas exits in the gaseous state.

5. The method of claim 1, wherein the step of rapidly cooling the light source body starts from a temperature of 150° C. or higher.

6. The method of claim 1, wherein the step of rapidly cooling the light source body comprises a step of injecting a cooling gas to the light source body.

7. An apparatus for manufacturing a surface light source device, comprising:
a forming section for forming a light source body including a plurality of discharge spaces into which a discharge gas is injected;
an exhaust section for removing impurities being present in the discharge spaces;
a diffusion section for diffusing a mercury gas into the discharge spaces; and
a rapid-cooling section for rapidly cooling the light source body, from a temperature at which mercury exists in the gaseous state to a room temperature.

8. The apparatus of claim 7, wherein the rapid-cooling section comprises a nozzle for injecting a cooling gas.
